(19) United States
(12) Patent Application Publication
(10) Pub. No.: US 2005/0262117 A1
(43) Pub. Date: Nov. 24, 2005

(54) Lightweight portal

(75) Inventor: Chris Jolley, Broomfield, CO (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/131,618

(22) Filed: May 18, 2005

Related U.S. Application Data
(60) Provisional application No. 60/573,221, filed on May 21, 2004.

(51) Int. Cl. G06F 17/00; G06F 9/44

(52) U.S. Cl. 707/100; 717/115

(57) ABSTRACT

Lightweight portal code can be used to produce a portal file from a portal file. The lightweight portal code need not have code for producing a portal from a database.

### CLAIM OF PRIORITY

This application claims priority to U.S. Provisional Application No. 60/573,221 entitled “Lightweight Portal” filed May 21, 2004. [Attorney's Docket No. BEAS-01613US0]

### FIELD OF THE INVENTION

The present invention is directed to portal technology.

### BACKGROUND

Portals can provide access to information networks and/or sets of services through the World Wide Web and other computer networks. Portals can provide a single point of access to data and applications, making them valuable to developers, businesses, and consumers alike. A portal can present a unified and personalized view of enterprise information to employees, customers, and business partners. In many implementations, portal applications can include web application views designed as a portal.

Portals are capable of presenting multiple web application views within a single web interface. In addition to regular web content that can appear in a portal, portals provide the ability to display portlets (self-contained applications or content) in a single web interface. Portals can also support multiple pages with menu-based or custom navigation for accessing the individualized content and portlets for each page.

A working portal can be defined by a portal configuration. The portal configuration can include a portal definition such as a file including Extensible Markup Language (XML); portlet definition files for any portlets associated with the portal; java server pages (JSPs); web application descriptors; images such as graphics interchange format files (GIFs); deployment descriptors, configuration files, the java archive (JAR) files that contain the logic and formatting instructions for the portal application; and any other files necessary for the desired portal application.

### BRIEF DESCRIPTION OF THE FIGURES

FIGS. 1A-1B are diagrams that illustrate code for a portal product of one embodiment of the present invention.

FIG. 2 illustrates a system of one embodiment of the present invention.

FIGS. 3A-3B illustrates systems of embodiments of the present invention.

### DETAILED DESCRIPTION

Portals can provide access to information networks and/or sets of services through the World Wide Web (WWW) or other computer networks. These networks can range from broad interconnections of computing systems such as the Internet to localized area networks including a few computers located in close geographic proximity such as a home or office. Portal applications can include web application views designed as a portal.

Portlets can be implemented as java server pages (JSPs) referenced by XML-based metadata of the portal descriptor. Portlets can utilize various types of display code to display highly focused information directed to a specific user or user group, having a portal as its container. Portlets can be comprised of portlet components which include portlet attributes (i.e. whether the portlet is editable, floatable, minimizable, maximizable, helpable, mandatory, has defaults minimized, or whether login is required) and portlet layout elements or components (i.e. banner, header, content, and footer sections). In one embodiment, a portlet is defined by a file that contains a portlet's XML-based metadata, which is created and edited by an integrated design environment or administration tool. Portlets can also be associated with portlet resource files including skeleton JSPs (one for each portlet layout element) and image files saved to a local file system by portal designer of integrated design environment.

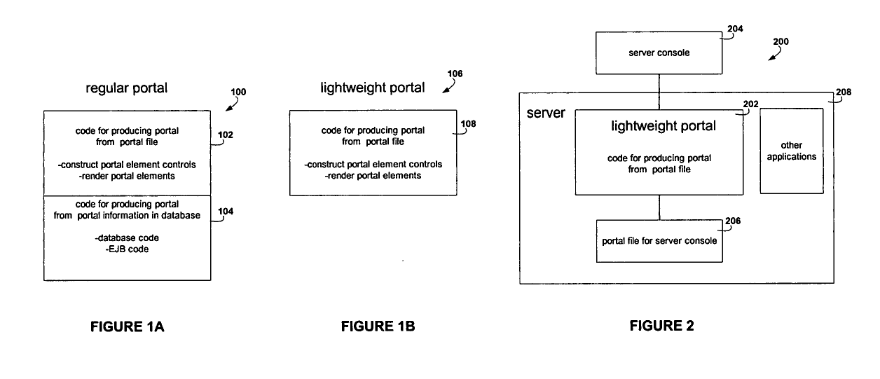

FIG. 1A illustrates a system 100 for producing portals. The system 100 includes code 102 that allows a user to construct a portal from portal file without using database and additional code 104 that allows the user to construct a portal from portal information stored in a database.

The portal file can be XML that indicates the portlet elements. The portal elements indicated by the portal file can include a desktop, menus, books, pages, portlets JSP content, look and feel info, images and other elements for constructing a portal.

Constructing a portal directly from a portal file is useful for developers who can modify the portal file or portal elements (such as with an Integrated Design Environment (IDE) for creating portals) and quickly see the changes in a displayed portal.

Additional code 104 can be used for constructing a portal from a database. The portal file and portal elements can be used to obtain portal information for storing in a database. The use of a database allows the portal system to scale for a large number of users. Additionally, in one embodiment, modified portal versions can be stored in the database. The modified portal versions can be produced by an administration tool. The use of modified versions in the database allows for the customization of the portals. The additional code 104 can include database code and Enterprise Java Bean (EJB) code for interacting with the database.

The construction of the portal can use controls, such as User Interface (UI) controls. In one embodiment, controls are created for portal elements as indicated by the portal file or portal information in the database. A control tree of the control hierarchy can be constructed from the portal file or portal information in the database. The controls can interact with developers using backing files, skeleton JSPs, backing context and presentation context. Details of one embodiment is described in the Appendix I and in the patent application “BACKING FILES AND BACKING CONTEXT FOR PORTAL ELEMENT CONTROLS”, Ser. No. 60/573,267, filed May 21, 2004, (corresponding to attorney docket number BEAS-01612US0), which is incorporated herein by reference.

FIG. 1B shows a system 106 with code 102 that allows a user to construct a portal from a portal file without using a database. The system 106 does not including additional code that allows the user to construct a portal from portal information stored in a database. This system 106 can be called lightweight portal.

Lightweight portal has a smaller code size than the regular portal system shown in FIG. 1A. In one embodiment, database code and EJB code are not required and this can significantly reduce the total code size.

Lightweight portal is useful for developers. Additionally, lightweight portal is useful for creating portals when the regular portal system would use too many resources or be too large.

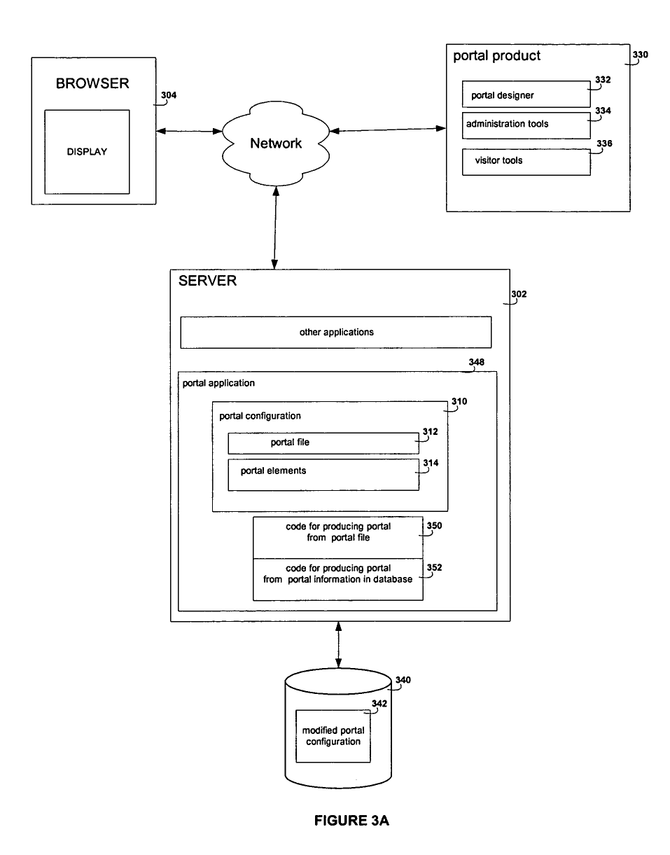

FIG. 2 shows a system 200 using lightweight portal. The system 200 includes code 202 that allows a user to construct a portal from portal file 206 without using a database; and a portal 204 constructed with the code. The portal 204 does not use a database to be constructed.

In one embodiment, the portal 204 is a console. The console can be an administration console for a server 208. Since lightweight portal is used, the total code size of the server is kept low. In one embodiment, the lightweight portal is used to produce a console for the WebLogic Server™ (WLS) and the WebLogic Enterprise Security™ (WLES) available from BEA systems, Inc. of San Jose, Calif.

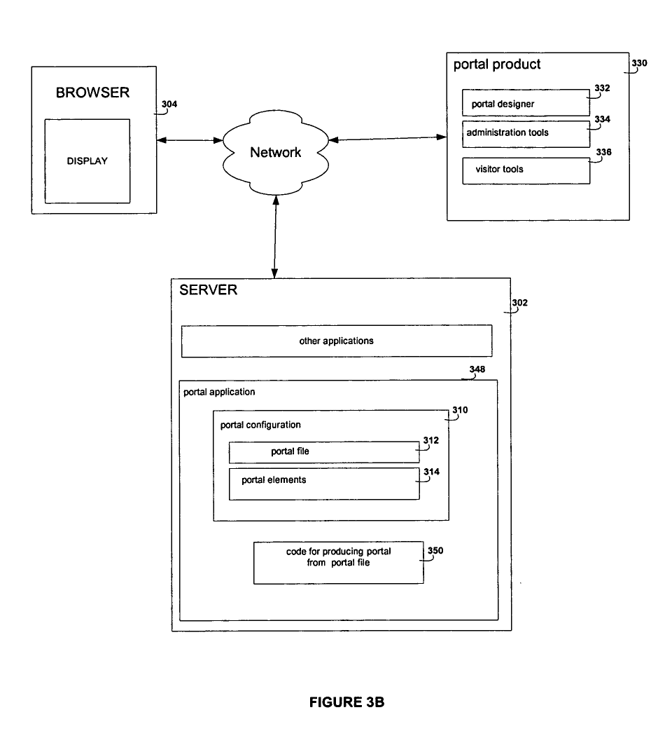

FIG. 3A illustrates a system for implementing one embodiment of the present invention. Server 302 can be used to produce the portal for display at the browser 304. In one embodiment, the server 302 produces a portal display in response to a request from the browser client 304. The portal can be configured for different users and different group of users, where different portlets can be displayed based upon a user's group or role. The server 302 can use a portlet configuration 310. The portlet configuration can include a portal file 312 which can be an XML file indicating the portal elements. The server 302 can use portal file 312 to construct a control tree of the portal element controls. The portal element controls can execute to produce the portal.

The server 302 can be software that can be run on one or more server machines. In one embodiment, the server 302 is a WebLogic Server™ available BEA Systems Inc., of San Jose, Calif.

A portal product 330 can be an Integrated Design Environment (IDE) for producing the portal. In one embodiment, the IDE includes a portal designer 332 for the design of the portal, portlets and other portal elements. The administration tools 334 and visitor tools 336 are used for producing versions of the portal. In one embodiment, the different versions uses the portal configuration 310 to produce a modified portal configuration 342 that can be stored in a database 340. Portals can be produced from the database 340, a cache or directly from the portal configuration 310.

The portal application 348 can include code 350 to directly produce the portal from the portal file 310 and additional code 352 to provide a portal from a portal configuration 342 stored in a database.

FIG. 3B shows a lightweight portal version where the portal application 348 does not include code for producing a portal from portal information in a database.

Appendix I shows a non-limiting example of one embodiment of the present invention.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, micro drive, and magneto-optical disks, ROMs, Rams, EPROM's, EPROM's, Drams, Rams, flash memory devices, magnetic or optical cards, Nanoscale systems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps performed in the embodiments of the invention disclosed can be performed in alternate orders, certain steps can be omitted, and additional steps can be added. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

### JVM Parameter Values

The following JVM parameters shown in Table 1.0 proved to be the best for the hardware configurations listed in Table 2.0.

TABLE 1.0
High Performing JVM parameters

| JVM | W2K | Linux | Solaris |
|---|---|---|---|
| BEA | -Xms1024 | -Xms1024 | -Xms1024 |
| jrockit81sp2_141_05 | -Xmx1024 | -Xmx1024 | -Xmx1024 |
| | -Xgc:parallel | -Xgc:parallel | -Xgc:parallel |
| JDK 1.4.1_05 | -Xms1024 | -Xms1024 | -Xms1024 |
| server VM | -Xmx1024 | -Xmx1024 | -Xmx1024 |
| | -XX:NewRatio=2 | -XX:NewRatio=2 | -XX:NewRatio=2 |
| | -XX:MaxPermSize=128m | -XX:+UseParallelGC | -XX:+UseParallelGC |
| | | -XX:MaxPermSize=128m | -XX:MaxPermSize=128m |

TABLE 2.0
Hardware used in WLP8.1 sp2 load testing

| | CPUs * | | | Physical | | Hardware | |
|---|---|---|---|---|---|---|---|
| Platform Name | CPU speed | | CPU type | Memory | CPU bits | Model | OS |
| W2K | 1 * 3.0 | GHz | Intel | 2048 MB | 32 | Dell 650 | Microsoft Windows 2000, |
| | | | Pentium ® 4 | | | | Advanced Server |
| Linux | 1 * 3.0 | GHz | Intel | 2048 MB | 32 | Dell 650 | Red Hat Linux Advanced |
| | | | Pentium ® 4 | | | | Server release 2.1AS/i686 |
| | | | | | | | (Pensacola) |
| Solaris | 2 * 1002 | MHz | Sun's sparcv9 | 2048 MB | 64 | Sun 240V | SunOS 5.9 |
| | | | processor | | | | |

1. A system comprising:
code that allows a user to construct a portal from portal file without using a database, the system not including additional code that allows the user to construct a portal from portal information stored in a database.

2. The system of claim 1, wherein the portal file is XML that indicates the portlet elements.

3. The system of claim 1, wherein the portal file indicates portal elements including portlets and pages.

4. The system of claim 1, wherein controls are created for portal elements indicated by the portal file.

5. The system of claim 1, wherein a control tree is constructed from the portal file.

6. A system comprising:
code that allows a user to construct a portal from portal file without using a database; and
a portal constructed with the code, the portal not using a database to be constructed.

7. The system of claim 6, wherein the portal file is XML that indicates the portlet elements.

8. The system of claim 6, wherein controls are created for portal elements indicated by the portal file.

9. The system of claim 6, wherein a control tree is constructed from the portal file.

10. The system of claim 6, wherein the portal is a console.

11. The system of claim 10, wherein the console is an administration console for a server.

12. A system for producing portals comprising:
code that allows a user to construct a portal from portal file without using a database; and
additional code that allows the user to construct a portal from portal information stored in a database.

13. The system of claim 12, wherein the portal file is XML that indicates the portlet elements.

14. The system of claim 12, wherein the additional code includes EJB code.

15. The system of claim 12, wherein controls are created for portal elements indicated by the portal file.

16. The system of claim 12, wherein a control tree is constructed from the portal file.

17. The system of claim 12, wherein controls are created for portal elements indicated by the portal information stored in the database.

18. The system of claim 12, wherein a control tree is constructed from the portal information stored in the database.

19. The system of claim 12, wherein the portal information stored in the database is derived from the portal file.

20. The system of claim 12, wherein the portal information stored in the database is a modified portal version derived from the portal file.
